(19) United States
(12) Patent Application Publication
(10) Pub. No.: US 2024/0022437 A1
(43) Pub. Date: Jan. 18, 2024

(54) METHOD FOR EVALUATING PROBABILITY OF ATTACK ON SMART CONTRACT

(71) Applicant: BEIJING LINGTRACE SECURITY TECHNOLOGY CO., LTD., Beijing (CN)

(72) Inventor: Yuefei Tan, Beijing (CN)

(21) Appl. No.: 18/334,160

(22) Filed: Jun. 13, 2023

(30) Foreign Application Priority Data
Jul. 15, 2022 (CN) 202210837408.9

(51) Int. Cl. H04L 9/40; H04L 9/00

(52) U.S. Cl. CPC H04L 9/40; H04L 9/50; H04L 2209/56

(57) ABSTRACT

The present disclosure provides a method for evaluating a probability of an attack on a smart contract. The method specifically includes: determining a number of Token₁ and a number of Token₂ in a liquidity provider (LP) contract, determining a price of Token₁ and a price of Token₂ at a moment t, and determining a deployment time of the LP contract; and obtaining a total value of Token₁ and a total value of Token₂ according to the number of Token₁, the number of Token₂, the price of Token₁, and the price of Token₂, and determining a probability of an attack on the LP contract, where the probability is determined according to the total value of Token₁, the total value of Token₂, and the deployment time of the contract.

### CROSS REFERENCE TO RELATED APPLICATION

This patent application claims the benefit and priority of Chinese Patent Application No. 202210837408.9, filed with the China National Intellectual Property Administration on Jul. 15, 2022, the disclosure of which is incorporated by reference herein in its entirety as part of the present application.

### TECHNICAL FIELD

The present disclosure belongs to the technical field of block-chains, and particularly relates to a method for evaluating a probability of an attack on a smart contract.

### BACKGROUND

Decentralized financial applications (DeFi Apps) have been widely developed and deployed on public blockchains, especially such public blockchain platforms as Ethereum, BNB Chain and Heco Chain, which are compatible with the Ethereum Virtual Machine. Decentralized exchanges (DEXs) are a kind of DeFi App that determines the price of cryptographic tokens through a constant product market maker (CPMM) algorithm.

To be more specific, two paired tokens Token₁ and Token₂ will be saved in a trading pair smart contract, which is generally referred to as a liquidity provider (LP) contract. In this LP contract, a constant value equals the number of Token₁* the number of Token₂. If a user injects a large amount of Token₁ into the LP contract in a short time, the price of Token₁ with Token₂ as unit will be lowered quickly in a short time. With such a manipulation way, hackers possibly launch attacks, causing loss for token holders. However, the absence of methods for evaluating the probability of attacks on smart contracts based on the price of the tokens leads to an enormous security risk.

In view of the above technical problems, the present disclosure provides a method for evaluating a probability of an attack on a smart contract.

### SUMMARY

In order to achieve an objective of the present disclosure, the present disclosure uses the following technical solutions:

According an aspect of the present disclosure, a method for evaluating a probability of an attack on a smart contract is provided.

The method for evaluating a probability of an attack on a smart contract specifically includes:
S1: determining a number of Token₁ and a number of Token₂ in a liquidity provider (LP) contract, determining a price of Token₁ and a price of Token₂ at a moment t, and determining a deployment time of the LP contract; and
S2: obtaining a total value of Token₁ and a total value of Token₂ according to the number of Token₁, the number of Token₂, the price of Token₁, and the price of Token₂, and determining a probability of an attack on the LP contract, where the probability is determined according to the total value of Token₁, the total value of Token₂, and the deployment time of the contract.

The price of Token₁ and the price of Token₂ at the moment t are determined by using the number of Token₁ and the number of Token₂ in the LP contract, to determine the total value of Token₁ and the total value of Token₂. The probability of an attack on the LP contract is determined according to the total value of Token₁, the total value of Token₂ and the deployment time of the contract. Therefore, a technical problem that an original method cannot effectively evaluate the probability of an attack on a smart contract, resulting in an enormous security risk is solved. The probability of an attack on the smart contract is determined by tracking the price of the token, so as to greatly protect the interests of the holder and prevent hackers from attacking for improper interests.

The price of Token₁ and the price of Token₂ in the LP contract at the moment t are determined. The number of Token₁ and the number of Token₂ in the LP contract are determined. Therefore, the total value of Token₁ and the total value of Token₂ at the moment t are obtained. With the total value as a starting point, the probability of an attack on the LP contract is determined. Thus, people may strengthen preventive measures for the LP contract which is likely to be attacked, the attack risk is reduced to an initial phase, to better protect the interests of the holder. Furthermore, determining the probability of an attack by taking the price as a starting point is also more targeted and accurate. The higher the price of the LP contract is, the greater the probability of an attack is, which also has more reference significance than other parameters. Obtained results are more accurate and have a higher reference value.

In a further technical solution, a deployment time t₀ of the contract is read by locating an on-chain address of the LP contract.

By reading the deployment time t₀ of the contract after locating the on-chain address, the reading result is more real-time and accurate, and the deployment time may be automatically read and determined more conveniently and quickly.

In a further technical solution, the number of Token₁ and the number of Token₂ are obtained by querying a contract interface of the LP contract.

In a further technical solution, the price of Token₁ is queried according to the following steps:
S1: querying website prices of Token₁ at the moment t by means of an on-chain interface on different public information websites separately; and
S12: computing an arithmetic mean of the website prices of Token₁ at the moment t on the different public information websites, to obtain the average price of Token₁ at the moment t.

In a further technical solution, the price of Token₂ is queried according to the following steps:
S1: querying website prices of Token₂ at the moment t by means of an on-chain interface on different public information websites separately; and
S12: computing an arithmetic mean of the website prices of Token₂ at the moment t on the different public information websites, to obtain the average price of Token₂ at the moment t.

In a technical solution further described, the total value of Token₁ equals the price of Token₁ multiplied by the number of Token₁; the total value of Token₂ equals the price of Token₂ multiplied by the number of Token₂; and the sum MarketValue of the total values of Token₁ and Token₂ in the LP contract equals the total value of Token₁ plus the total value of Token₂.

In a further technical solution, the method for evaluating a probability of an attack on a smart contract further includes: determining a critical price M̅a̅r̅k̅e̅t̅V̅a̅l̅u̅e̅ according to an average value of attacked LP contracts in publicly reported attack events counted within a first time threshold.

The accuracy of final evaluation prediction is further improved according to the critical price in combination with an actual situation.

In a further technical solution, the probability of an attack is:

P=λ* MarketValue/(MarketValue+M̅a̅r̅k̅e̅t̅V̅a̅l̅u̅e̅)*e^{-(t-t}^{₀}⁾
where λ is a constant, and is determined by scores from experts according to the price of Token₁ and the price of Token₂ in the LP contract.

By quantizing the probability of an attack, the probability of an attack is more accurately grasped, to improve the entire reliability.

In a further technical solution, when the probability of an attack is greater than a first threshold, it indicates an alert phase, and a monitoring period of the LP contract is required to be shortened; when the alert phase lasts for a time greater than a second time threshold and the probability of an attack is less than the first threshold, the alert phase is quit; and when the probability of an attack is greater than a third threshold, the LP contract's owner should be notified immediately.

In a further technical solution, in an alert phase, when the probability of an attack is greater than a second threshold, the LP contract's owner should be notified immediately, a first threshold being less than the second threshold, and the second threshold being less than a third threshold.

In the alert phase, the probability of being attacked is extremely high, in order to find the risk of being attacked as soon as possible, a second threshold which is greater than the first threshold and less than the third threshold is set, such that the relevant risk may be sent to relevant personnel first, so as to further reduce the probability of suffering losses.

In another aspect, an embodiment of the present application provides a computer-readable storage medium, storing a computer program. When the computer program is executed in a computer, the computer executes the above method for evaluating a probability of an attack on a smart contract.

In yet another aspect, an embodiment of the present application provides a computer program product. The computer program product stores an instruction, and when the instruction is executed by a computer, the computer implements the above method for evaluating a probability of an attack on a smart contract.

### BRIEF DESCRIPTION OF THE DRAWINGS

The above and other features and advantages of the present disclosure will become more apparent by describing illustrative implementation modes in detail with reference to the accompanying drawings.

FIG. 1 is a flowchart of a method for evaluating a probability of an attack on a smart contract according to Embodiment 1.

FIG. 2 is a flowchart of a querying process for a price of Token₁ in Embodiment 1.

FIG. 3 is a structural diagram of a computer-readable storage medium in Embodiment 2.

### DETAILED DESCRIPTION OF THE EMBODIMENTS

The illustrative implementation modes are described more comprehensively below with reference to the accompanying drawings. However, the illustrative implementation modes can be implemented in various forms, and should not be construed as being limited to those described herein. On the contrary, these implementation modes are provided to make the present disclosure comprehensive and complete and to fully convey the concept of the illustrative implementation modes to those skilled in the art. The same reference numerals in the figures indicate the same or similar structures, and thus their detailed descriptions are omitted.

The terms “a”, “an”, and “the” are used to indicate that there are one or more elements/components/etc. The terms “comprise” and “have” are used to mean open-ended inclusion and mean that there may be additional elements/components/etc. besides the listed elements/components/etc.

### Embodiment 1

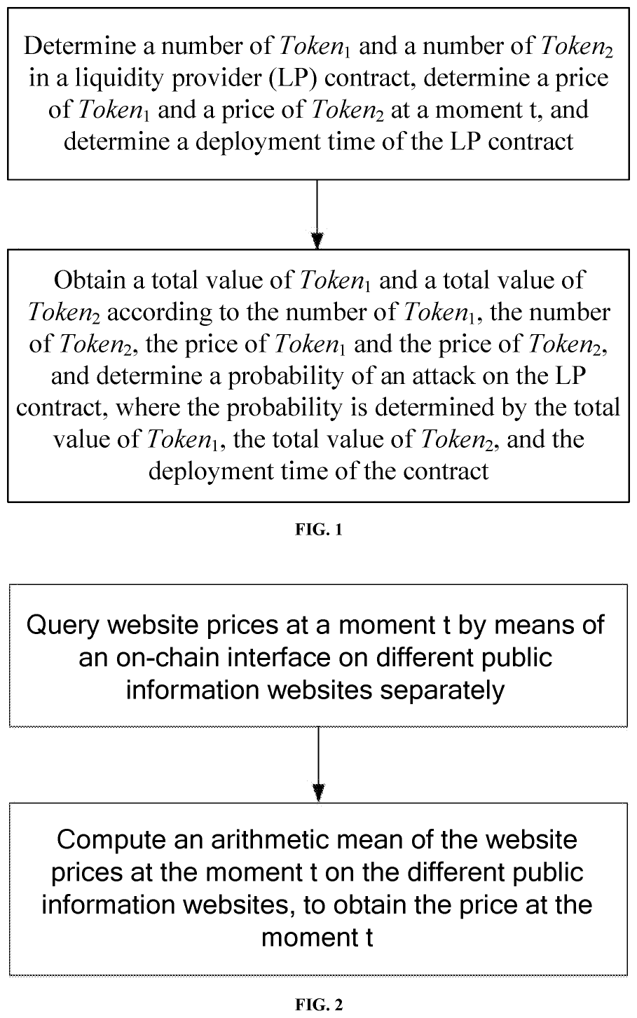

As shown in FIG. 1, according an aspect of the present disclosure, provided is a method for evaluating a probability of an attack on a smart contract.

The method for evaluating a probability of an attack on a smart contract specifically includes:
S1: determine a number of Token₁ and a number of Token₂ in a liquidity provider (LP) contract, determine a price of Token₁ and a price of Token₂ at a moment t, and determine a deployment time of the LP contract; and
S2: obtain a total value of Token₁ and a total value of Token₂ according to the number of Token₁, the number of Token₂, the price of Token₁, and the price of Token₂, and determine a probability of an attack on the LP contract, where the probability is determined according to the total value of Token₁, the total value of Token₂, and the deployment time of the contract.

The price of Token₁ and the price of Token₂ at the moment t are determined by using the number of Token₁ and the number of Token₂ in the LP contract, to determine the total value of Token₁ and the total value of Token₂, and the probability of an attack on the LP contract is determined according to the total value of Token₁, the total value of Token₂ and the deployment time of the contract, such that a technical problem that an original method cannot effectively evaluate the probability of an attack on a smart contract, resulting in an enormous security risk is solved, and then the probability of an attack on the smart contract is determined by tracking the price of the token, so as to greatly protect the interests of the holder and prevent hackers from attacking for improper interests.

The price of Token₁ and the price of Token₂ in the LP contract at the moment t are determined, and the number of Token₁ and the number of Token₂ in the LP contract are determined, such that the total value of Token₁ and the total value of Token₂ at the moment t are obtained. With the total value as a starting point, the probability of an attack on the LP contract is determined, such that people may strengthen preventive measures for the LP contract which is likely to be attacked. The attack risk is reduced to an initial phase, to better protect the interests of the holder. Furthermore, determining the probability of an attack by taking the price as a starting point is also more targeted and accurate. The higher the price of the LP contract is, the greater the probability of an attack is, which also has more reference significance than other parameters, and obtained results are more accurate and have a higher reference value.

LP smart contracts are widely deployed in public chain systems. Such smart contracts are frequently attacked by hackers because they contain encrypted tokens that have market values. Once a contract is attacked, holders of an encrypted token in the contract suffer tremendous losses. The probability of an attack on an LP smart contract is analyzed quantitatively for the first time by means of an algorithm, and a calculation model and process are given.

In another possible embodiment, the price of the token may be a characteristic quantity indicative of scarcity and difficulty of the token, for example, difficulty of obtaining the token, a market value of the token, etc. An address of the LP contract begins with 0x.

In another possible embodiment, a deployment time t₀ of the contract is read by locating an on-chain address of the LP contract.

By reading the deployment time t₀ of the contract after locating the on-chain address, a reading result is more real-time and accurate, and the deployment time may be automatically read and determined more conveniently and quickly.

In another possible embodiment, the number of Token₁ and the number of Token₂ are obtained by querying a contract interface of the LP contract.

In another possible embodiment, a price of Token₁ is queried according to the following steps:
S1: query website prices of Token₁ at the moment t by means of an on-chain interface on different public information websites separately; and
S12: compute an arithmetic mean of the website prices of Token₁ at the moment t on the different public information websites, to obtain the average price of Token₁ at the moment t.

For a particular example, the Internet public information websites selected in the above process typically include CoinMarketCap (CMC), etc.

For example, the website price of each Token₂ on the j₂ Internet public information websites obtained through an application programming interface (API) query is Token₂CEXPrice₁, . . . , and Token₂CEXPricej₂. Accordingly, the average price of Token₂ is:

$$\overline{{Token}_{2} Price} = ( {\sum }_{n = 1}^{n = {j}_{2}} {Token}_{2} {CEXPrice}_{n} ) / {j}_{2} )$$

where Token₂CEXPriceₙ is the price queried from the nth website.

In another possible embodiment, as shown in FIG. 2, a price of Token₂ is queried according to the following steps:
S1: query website prices of Token₂ at the moment t by means of an on-chain interface on different public information websites separately; and
S12: compute an arithmetic mean of the website prices of Token₂ at the moment t on the different public information websites, to obtain the average price of Token₂ at the moment t.

In another possible embodiment, the total value of Token₁ equals the price of Token₁ multiplied by the number of Token₁; the total value of Token₂ equals the price of Token₂ multiplied by the number of Token₂; and the sum MarketValue of the total values of Token₁ and Token₂ in the LP contract equals the total value of Token₁ plus the total value of Token₂.

In another possible embodiment, the method for evaluating a probability of an attack on a smart contract further includes: determine a critical price M̅a̅r̅k̅e̅t̅V̅a̅l̅u̅e̅ according to an average price of attacked LP contracts in publicly reported attack events counted within a first time threshold.

The accuracy of final evaluation prediction is further improved according to the critical price in combination with an actual situation.

In another possible embodiment, the probability of an attack is:

P=λ* MarketValue/(MarketValue+M̅a̅r̅k̅e̅t̅V̅a̅l̅u̅e̅)*e^{-(t-t}^{₀}⁾
where λ is a constant, and is determined by scores from experts according to the price of Token₁ and the price of Token₂ in the LP contract.

By quantizing the probability of an attack, the probability of an attack is more accurately grasped, to improve the entire reliability.

In another possible embodiment, when the probability of an attack is greater than a first threshold, it indicates an alert phase, and a monitoring period of the LP contract is required to be shortened; when the alert phase lasts for a time greater than a second time threshold and the probability of an attack is less than the first threshold, the alert phase is quit; and when the probability of an attack is greater than a third threshold, the LP contract's owner should be notified immediately.

In another possible embodiment, in an alert phase, when the probability of an attack is greater than a second threshold, the LP contract's owner should be notified immediately, a first threshold being less than the second threshold, and the second threshold being less than a third threshold.

In the alert phase, the probability of being attacked is extremely high, in order to find the risk of being attacked as soon as possible, a second threshold which is greater than the first threshold and less than the third threshold is set, such that the relevant risk may be sent to relevant personnel first, so as to further reduce the probability of suffering losses.

For a particular example, under the condition that the first threshold is 0.3, the second threshold is 0.5 and the third threshold is 0.8, when the probability is 0.4, the alert phase is entered, and after the alert phase is entered, the probability is changed to be 0.6. In this case, the LP contract's owner should be notified immediately. Under the condition that after the alert phase is entered for a time greater than a first time threshold of 10 min, the probability is 0.2, the alert phase is quit, and when the probability at this moment is 0.9, which is greater than the third threshold, the LP contract's owner should be notified immediately.

### Embodiment 2

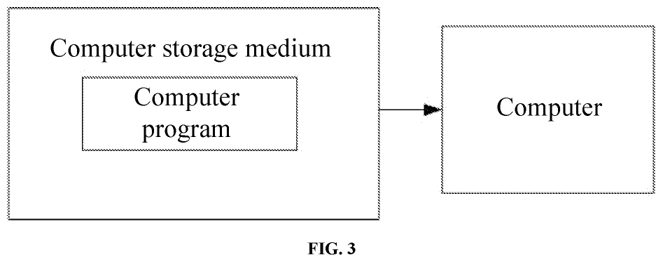

As shown in FIG. 3, in another aspect, provided in an embodiment of the present application is a computer-readable storage medium, storing a computer program. When the computer program is executed in a computer, the computer executes the above method for evaluating a probability of an attack on a smart contract.

### Embodiment 3

In yet another aspect, provided in an embodiment of the present application is a computer program product. The computer program product stores an instruction, and when the instruction is executed by a computer, the computer implements the above method for evaluating a probability of an attack on a smart contract.

In the embodiments of the present disclosure, the term “a plurality of” means two or more, unless otherwise specifically defined. Terms “mount”, “connect”, “fix”, etc. should be understood in a broad sense. For example, “connection” may be a fixed connection, a detachable connection or an integrated connection. Those of ordinary skill in the art may understand specific meanings of the above terms in the embodiments of the present disclosure based on a specific situation.

It should be understood that in the description of the embodiments of the present disclosure, the terms “up”, “down”, etc. indicate the orientation or position relationships based on the accompanying drawings. These terms are merely intended to facilitate description of the embodiments of the present disclosure and simplify the description, rather than to indicate or imply that the mentioned device or unit must have a specific direction and must be constructed and operated in a specific orientation. Therefore, these terms should not be construed as a limitation to the embodiments of the present disclosure.

In the description of this specification, the description of the terms “an embodiment”, “a preferred embodiment”, etc. means that the specific features, structures, materials, or characteristics described with reference to the embodiment or example are included in at least one embodiment or example of the embodiments of the present disclosure. In this specification, the schematic descriptions of the above terms do not necessarily refer to the same embodiment or example. Moreover, the specific features, structures, materials, or characteristics described may be combined in any suitable manner in any one or more embodiments or examples.

What are described above are merely preferred embodiments of the embodiments of the present disclosure, and are not intended to limit the embodiments of the present disclosure. Various changes and modifications may be made to the embodiments of the present disclosure by those skilled in the art. Any modifications, equivalent substitutions, improvements, etc. made within the spirit and scope of the embodiments of the present disclosure should be included within the protection scope of the embodiment of the present disclosure.

What is claimed is:

1. A method for evaluating a probability of an attack on a smart contract, comprising:
S1: determining a number of Token₁ and a number of Token₂ in a liquidity provider (LP) contract, determining a price of Token₁ and a price of Token₂ at a moment t, and determining a deployment time of the LP contract; and
S2: obtaining a total value of Token₁ and a total value of Token₂ according to the number of Token₁, the number of Token₂, the price of Token₁, and the price of Token₂, and determining a probability of an attack on the LP contract, wherein the probability is determined according to the total value of Token₁, the total value of Token₂, and the deployment time of the contract.

2. The method for evaluating a probability of an attack on a smart contract according to claim 1, wherein a deployment time t₀ of the contract is read by locating an on-chain address of the LP contract.

3. The method for evaluating a probability of an attack on a smart contract according to claim 1, wherein the number of Token₁ and the number of Token₂ are obtained by querying a contract interface of the LP contract.

4. The method for evaluating a probability of an attack on a smart contract according to claim 1, wherein the price of Token₁ is queried according to the following steps:
S1: querying website prices of Token₁ at the moment t by means of an on-chain interface on different public information websites separately; and
S12: computing an arithmetic mean of the website prices of Token₁ at the moment t on the different public information websites, to obtain the average price of Token₁ at the moment t.

5. The method for evaluating a probability of an attack on a smart contract according to claim 1, wherein the price of Token₂ is queried according to the following steps:
S1: querying website prices of Token₂ at a moment t by means of an on-chain interface on different public information websites separately; and
S12: computing an arithmetic mean of the website prices of Token₂ at the moment t on the different public information websites, to obtain the average price of Token₂ at the moment t.

6. The method for evaluating a probability of an attack on a smart contract according to claim 1, wherein the total value of Token₁ equals the price of Token₁ multiplied by the number of Token₁; the total value of Token₂ equals the price of Token₂ multiplied by the number of Token₂; and the sum MarketValue of the total values of Token₁ and Token₂ in the LP contract equals the total value of Token₁ plus the total value of Token₂.

7. The method for evaluating a probability of an attack on a smart contract according to claim 1, further comprising: determining a critical price M̅a̅r̅k̅e̅t̅V̅a̅l̅u̅e̅ according to an average price of attacked LP contracts in publicly reported attack events counted within a first time threshold.

8. The method for evaluating a probability of an attack on a smart contract according to claim 1, wherein the probability P of an attack is:
P=λ*MarketValue/(MarketValue+M̅a̅r̅k̅e̅t̅V̅a̅l̅u̅e̅)*e^{-(t-t}^{₀}⁾
wherein λ is a constant, and is determined by scores from experts according to the price of Token₁ and the price of Token₂ in the LP contract.

9. The method for evaluating a probability of an attack on a smart contract according to claim 1, wherein:
when the probability of an attack is greater than a first threshold, an alert phase is indicated, and a monitoring period of the LP contract is required to be shortened;
when the alert phase lasts for a time greater than a second time threshold and the probability of an attack is less than the first threshold, the alert phase is discontinued; and
when the probability of an attack is greater than a third threshold, a token holder of the LP contract is required to be notified immediately.

10. The method for evaluating a probability of an attack on a smart contract according to claim 1, wherein in an alert phase, when the probability of an attack is greater than a second threshold, a token holder of the LP contract is required to be notified immediately, a first threshold being less than the second threshold, and the second threshold being less than a third threshold.
